(19) United States
(12) Patent Application Publication
(10) Pub. No.: US 2009/0144610 A1
(43) Pub. Date: Jun. 4, 2009

(54) TRANSLATING XML WITH MULTIPLE NAMESPACE EXTENSIONS

(75) Inventor: Alan Gael Sheldon, Las Vegas, NV (US)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY. LIMITED, Lane Cove (AU)

(21) Appl. No.: 12/139,147

(22) Filed: Jun. 13, 2008

Related U.S. Application Data
(60) Provisional application No. 60/943,963, filed on Jun. 14, 2007.

(51) Int. Cl. G06F 17/00

(52) U.S. Cl. 715/234

(57) ABSTRACT

A plurality of namespace extensions in a XML file is managed. A file is parsed to identify the plurality of namespace extension elements. The namespace extension elements are grouped into a single element utilizing a set of rules.

### RELATED APPLICATIONS

This application claims priority to U.S. Provisional Patent Application Ser. No. 60/943,963, having a filing date of Jun. 14, 2007, entitled “Translating XML With Multiple Namespace Extensions”, which is hereby incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### FIELD

The present invention relates to translating XML (eXtensible Markup Language), and particularly, but not exclusively, to translating XML with multiple namespace extensions.

### BACKGROUND

XML (eXtensible Markup Language) is a text-based language which is capable of describing, categorizing and applying a hierarchical (tree-based) structure to any type of information. XML is designed to provide a language which describes any type of information in a simultaneously human-readable and machine-readable format. Moreover, XML provides a self-documenting format which describes structure and field names in addition to holding specific values. In other words, particular instances of the XML language can be developed to categorize and describe almost any type of information.

A XML document is primarily composed of a number of XML ‘elements’ which define an element type and also contain a particular instance of the element. Each element may also have one or more attributes. Attributes are values that are associated with the element. Attributes may be used to further describe characteristics of an element.

Each instance of a XML language is generally required to conform to a particular standard, to ensure that XML documents can be easily exchanged and understood between multiple independent parties.

To ensure that a XML document conforms to a standard, the XML document may be validated against a XML schema. A XML schema is a set of rules to which a XML document must conform if it is to be considered ‘valid’ (i.e. the document conforms to the standard). The set of rules are generally codified as a XML Schema Definition (XSD). The XSD is not necessarily static, but may be changed over time as extensions and additions are made to the XML language.

It may be necessary, in some instances, to bring together disparate XML documents (and perhaps disparate XML languages) from multiple independent parties, or to allow multiple independent parties to insert information into a common XML document or instance of a XML language. If such a process is not managed correctly, the resulting merged XML document may contain two or more different elements with identical element or attribute names. Such elements, while appearing to be identical, may in fact be different. In such a case, the merged XML document cannot be correctly validated by a XML schema.

Where two different XML documents utilize identical element or attribute names to describe different (non-compatible) data, the potential confusion caused can be ameliorated by the use of a namespace convention. When a particular element or attribute is described in a XML document, the element or attribute is attributed a unique namespace to ensure that it is not confused with an element or attribute from another document. Of course, such a change must also be reflected in the XML schema, so that any document parsed using the schema is considered valid.

In some cases, a XML schema designer will attempt to preempt the addition of new elements by an independent party. This is done by the insertion of a tag such as <xs:any namespace=“##other”>, where ‘xs’ is the XML schema namespace. This allows both the base schema and the namespace extensions to be validated at the schema level based on the base schema and the namespace extensions.

Existing tools can use this convention to create and use a XSD (XML Schema Definition) with a single allowed namespace extension at an allowed position in the base schema. However, problems arise where multiple namespace extensions are required in the same position (for example, where different independent parties all wish to utilize the single allowed namespace extension).

In the following description, the term “XML file” is used to refer to any file that contains XML related text, and is intended to include a XML document, a XML Schema Definition, a XML schema or any other file that contains text compatible with any aspect of any XML language. The term “XML document” is used to refer to a file that contains a particular instance of XML. The term “XML schema” is used to denote a description of a type of XML document, normally used to validate the XML document. The term “XML Schema” (capital ‘S’) is used to denote a particular XML Schema language, published by W3C as a standard in May 2001 (accessible via http://www.w3c.org). The term XML Schema Definition is used to denote a particular instance of an XML schema that is compatible with XML Schema.

### SUMMARY

In a first aspect, the present invention provides a method for managing a plurality of namespace extensions in a XML file, comprising the steps of, parsing the file to identify the plurality of namespace extension elements, and grouping the namespace extension elements into a single element.

The step of grouping the namespace extensions may comprise the further step of utilizing a set of rules to group the namespace extensions into the single element.

The set of rules may include the rule of parsing each namespace extension element, identifying a common aspect to each of the namespace extension elements, identifying a difference between each of the namespace extension elements, and concatenating each difference to the common aspect.

A new XML file may be created, and the single element may be inserted into the XML file in place of the plurality of namespace extension elements.

The XML file may be a XML schema which may be a XML Schema Definition.

In a second aspect, the invention provides a method for managing a single namespace extension in a XML file, where the single namespace extension element contains plurality of elements, comprising the steps of, parsing the file to identify the plurality of namespace extension elements contained within the single element, and extracting the plurality of namespace extension elements into separate elements.

In a third aspect, the invention provides a system for managing a plurality of namespace extensions in a XML file, comprising a parser which parses the file to identify the plurality of namespace extension elements, and a grouper which groups the namespace extension elements into a single element.

In a fourth aspect, the invention provides a system for managing a single namespace extension in a XML file, where the single namespace extension element contains a plurality of elements, comprising, a parser which parses the file to identify the plurality of namespace extension elements contained within the single element, and an extractor which extracts the plurality of namespace extension elements into separate elements.

In a fifth aspect, the invention provides computer program code arranged to, when loaded on a computing system, perform the method steps of one of the first aspect and the second aspect of the invention.

In a sixth aspect, the invention provides a computer readable media incorporating computer program code in accordance a fifth aspect of the invention.

In a seventh aspect, the inventor provides a data signal comprising the program code in accordance with a fifth aspect of the invention.

### BRIEF DESCRIPTION OF THE DRAWINGS

FIG. 1 is an example computing system capable of implementing an embodiment of the invention;

FIG. 2 is an example network environment capable of interacting with an embodiment of the invention;

FIG. 3 is a schematic diagram illustrating the component parts of a software application in accordance with an embodiment of the invention; and

FIGS. 4a and 4b are flow charts depicting the method steps according to an embodiment of the invention.

### DETAILED DESCRIPTION

The embodiment described herein provides a system, method and software application for the creation of a protocol, based on XML, which allows multiple elements to be added (by one or more independent parties) at the same position in a XML Schema Definition, although it will be understood that the system, method and software application may be used to modify any type of XML file. Moreover, the embodiment provides a mechanism by which the multiple elements added to a single namespace extension in a XML Schema Definition may be correctly interpreted by a receiving computer.

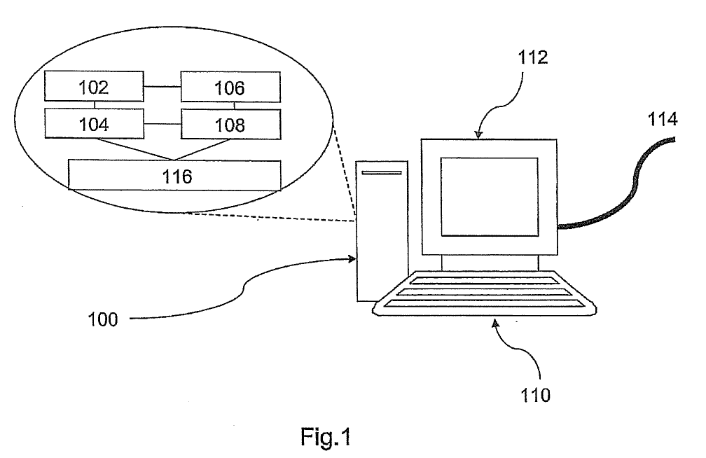

The methodology (and associated software application) in accordance with an embodiment of the invention may be executed on a computing system such as the example computing system shown in FIG. 1. At FIG. 1 there is shown a schematic diagram of a computing system 100 suitable for use with an embodiment of the present invention. The computing system 100 may be used to execute applications and/or system services in accordance with an embodiment of the present invention. The computing system 100 preferably comprises a processor 102, read only memory (ROM) 104, random access memory (RAM) 106, and input/output devices such as disk drives 108, keyboard 110 (or other input peripherals such as a mouse, not shown), display 112 (or other output peripherals such as a printer, not shown) and communications link 114. The computer includes programs that may be stored in ROM 104, RAM 106, or disk drives 108 and may be executed by the processor 102. The communications link 114 connects to a computer network but could be connected to a telephone line, an antenna, a gateway or any other type of communications link. Disk drives 108 may include any suitable storage media, such as, for example, floppy disk drives, hard disk drives, CD ROM drives or magnetic tape drives. The computing system 100 may use a single disk drive or multiple disk drives. The computing system 100 may use any suitable operating system, such as Windows™ or Unix™. The computing system 100 may be a gaming server arranged to send gaming information to one or more gaming machines. The computing system 100 may be capable of executing a software application 116 (which may be in the form of an API) in accordance with an embodiment of the invention.

It will be understood that the computing system described in the preceding paragraphs is illustrative only and that the presently described embodiment or other embodiments which fall within the scope of the claims of the present application may be executed on any suitable computing system, which in turn may be realized utilizing any suitable hardware and/or software. Other computing systems that may be suitable include server computers, hand-held or portable computing devices, consumer electronics, and other devices capable of receiving electronic information, including automated ‘teller’ machines and vending machines.

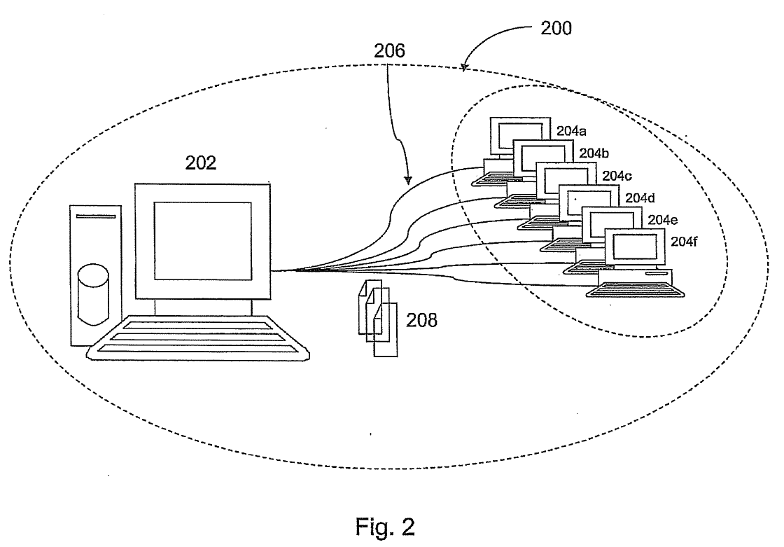

FIG. 2 illustrates an example network environment 200, with a server computer 202 in communication with client computers 204a, 204b, 204c, etc., via a network (or a bus) 206, in which an embodiment of the present invention may be employed. In more detail, the server 202 may be a gaming server, arranged to interconnect a number of gaming machines 204a, 204b, 204c, etc., via the communications network 206, which may be a local or wide area network, such as an intranet, the Internet, etc. It will be understood that the client computers need not be gaming machines, but may be a terminal, another computing system, a portable communications device, such as a mobile telephone, or any other device capable of receiving information from the server.

The server 202, and the client devices 204a, 204b, 204c, etc., may communicate with each other over the communications network 206 by use of any suitable networking protocol, such as TCP/IP, GSA G2S (Gaming Standards Association Game-to-System protocol), GSA S2S (Gaming Standards Association System-to-System protocol) or any other suitable protocol for the exchange of information 208. The exchange of information may include the provision of XML files, the XML files providing information to be utilized by any or all of the servers and client devices in the communications network 206.

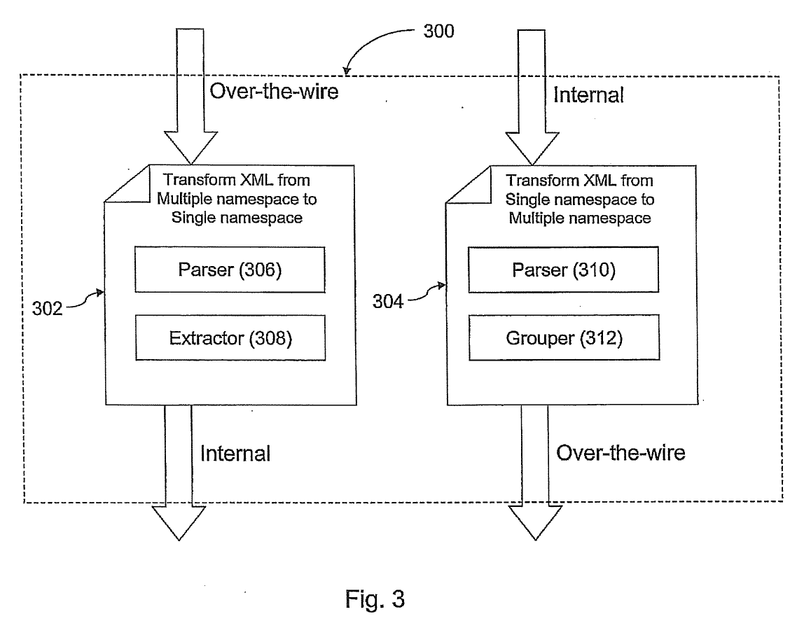

FIG. 3 is a schematic diagram illustrating the components of a software application in accordance with an embodiment of the present invention. The software application 300 is comprised of two modules or transformers 302 and 304, although it will be understood that modules 302 and 304 may exist as separate software applications. The first module includes a first parser 306 to parse a XML file with multiple elements, and a grouper 308 to group the multiple elements into a single element that incorporates the multiple elements of the original XML file, and the second module includes a second parser 310 to parse a XML file with a single element that contains multiple incorporated elements and an extractor 312 to extract the multiple incorporated elements into a separated multiple element format.

The operation of the software application is best illustrated with reference to an example. A fragment of a XML document, which describes a validation for a single allowable namespace extension, is shown below:

XML Fragment 1: Single namespace extension

<base:document

xmlns:base=“http://example.com/base”>
xmlns:ext=“http://example.com/ext”>

<base:element0>

<ext:element1 />

</base:element0>

</base:Document>

In the XML fragment shown above, a single namespace extension of type ‘ext’ is provided. That is, the namespace extension ‘ext’ allows a third party to insert an element to be added to a XML file and to be validated by the XML Schema Definition. However, if two separate users insert elements, the code fragment may include two separate and distinct namespace extensions. That is:

XML Fragment 2: Multiple elements added

<base:document

xmlns:base=“http://example.com/base”>
xmlns:ext1=“http://example.com/ext1”>
xmlns:ext2=“http://example.com/ext2”>

<base:element0>

<ext1:element1 />
<ext2:element2 />

</base:element0>

</base:Document>

As can be seen, two elements, namely ext1 and ext2, have been added to XML Fragment 2. Such a code fragment cannot be correctly or usefully interpreted using current applications or methodologies, as multiple namespace extensions are not allowed at the same position, according to a XML Schema Definition.

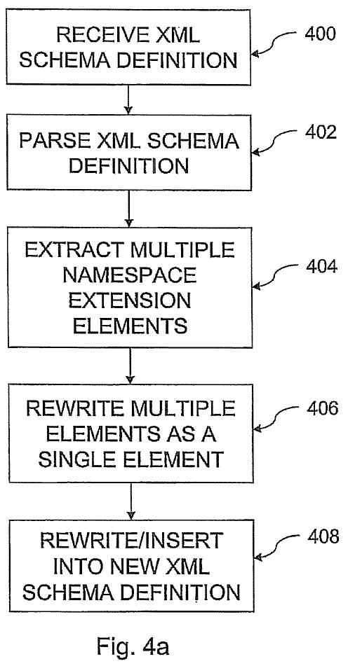

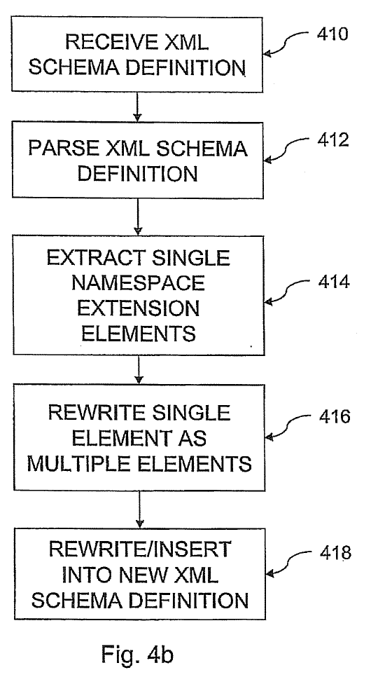

The embodiment described herein ameliorates this problem by providing a first transformer which creates a XML Schema Definition which includes a single namespace extension that aggregates or incorporates all of the elements in the XML namespace extension into a single element. This is achieved through the use of the software application of FIG. 3, which operates in the manner shown in the flow chart at FIG. 4a. The first translator, at step 400, receives a XML Schema Definition with multiple namespace extensions. The XML Schema Definition is parsed by a parser (step 402) to extract the multiple name space extensions (step 404). The extracted multiple namespace extensions are rewritten by a grouper into a single element (step 406).

The manner in which the query is rewritten may follow a suitable set of predetermined rules. In the example embodiment described herein, the common aspect of each of the elements in each of the namespace extensions is separated from the difference between each of the multiple name space extensions, and the difference between each of the extensions is concatenated as a single element to the end of the common aspect of each of the elements of each of the namespace extensions in the XML Schema Definition.

For example, the multiple elements listed in Fragment 2, namely xmlns:ext1=“http://example.com/ext1” and xmlns:ext2=“http://example.com/ext2”, are separated into their common portion, namely the portion “http://example.com/” and their different portion, namely “ext1” and “ext2”. The common portion then forms the primary portion of the new combined single element, with the different portions being concatenated (and separated by a dash) to form the new single element, namely xmlns:ext=“http://example.com/ext1-ext2”. It will be understood that this is only one of a large number of possible methods by which multiple elements may be combined into a single element.

Another example embodiment utilises the concatenation of multiple elements into a single element. For example, xmlns:ext1=“http://example.com/ext1” and xmlns:ext2=“http://example.com/ext2” may be combined to form the element xmlns:ext=“http://example.com/ext1-http://example.com/ext2”. It will be understood that the two example embodiments described herein are provided by way of example only, and other variations in the manner in which multiple elements are combined to form a single element are within the purview of a person skilled in the art.

The rewritten element is reinserted into the XML Schema Definition (step 408) or alternatively, a new XML Schema Definition may be created to contain the new values. The new XML Schema Definition is termed an ‘internal representation’, as it is the version of the XML Schema Definition which is understandable to an older or legacy computing system. For example, utilizing the methodology outlined in FIG. 4, the XML Fragment 2 is transformed to XML Fragment 3, shown below:

XML Fragment 3: Multiple elements
combined into a single element

<base:document

xmlns:base=“http://example.com/base”>
xmlns:ext=“http://example.com/ext1-ext2”>

<base:element0>

<ext:element1 />
<ext:element2 />

</base:element0>

</base:Document>

The transformed element allows the internal representation of the base schema to be consistent with accepted standards, and in particular, with the standard of the particular XML instance. This in turn allows instances of XML languages to be extended to allow for revisions and user extensions, while retaining backwards compatibility for systems and applications that employ prior Schema Definition versions.

However, while the internal representation is useful in situations where an older version of a XML schema is employed, it is necessary to convert XML Code Fragment 3 to the original representation with multiple namespace extensions when the XML is delivered to another computing system (termed an ‘over-the-wire’ representation). This is achieved by the second transformer, which, if required, utilizes the internal representation and transforms the internal representation into the original multiple namespace extension format. At a first step 410, the second transformer receives a XML Schema Definition with multiple namespace extensions. The XML Schema Definition is parsed by a parser (step 412) to identify the single combined name space extension element (step 414). The single combined namespace extension element is rewritten by an extractor into multiple elements (step 416).

The manner in which the query is rewritten may follow any suitable set of predetermined rules. In the first example given above, where multiple namespace extension elements are rewritten into a single element, the common aspect of each of the elements in each of the namespace extensions is separated from the difference between each of the multiple name space extensions is taken, and the difference between each of the extensions is concatenated, as a single element to the end of the common aspect of each of the elements of each of the namespace extensions in the XML Schema Definition. If such a method is used to convert from multiple name space extension elements to a single namespace extension element, then the reverse methodology is applied to convert ‘back’.

For example, the multiple elements listed in Fragment 2, namely xmlns:ext1=“http://example.com/ext1” and xmlns:ext2=“http://example.com/ext2”, were originally separated into their common portion, namely the portion “http://example.com/” and their different portions, namely “ext1” and “ext2”. The common portion then formed the primary portion of the new combined single element, with the different portions being concatenated (and separated by a dash) to form the new single element, namely xmlns:ext=“http://example.com/ext1-ext2”.

Therefore, to reverse this methodology, the new single element is broken up into corresponding parts, namely “ext1” and “ext2”. The query is then rewritten as two separate elements, namely xmlns:ext1=“http://example.com/ext1” and xmlns:ext2=“http://example.com/ext2”.

The rewritten elements are reinserted into the XML Schema (step 418) or alternatively, a new XML Schema Definition may be created to contain the new values. The new XML Schema Definition is termed an ‘over-the-wire representation’, as it is the version of the XML Schema Definition which is understandable and propagated throughout a computing network such as the one shown in FIG. 2.

One possible software application which could be used to specify and control transformer behavior is XSLT (eXtensible Stylesheet Language Transformations). XSLT is a template processing application primarily designed to transform one XML file into another XML file.

However, it will be understood that any suitable software application may be developed, in any suitable programming language, to develop a program which carries out the method steps of the embodiment and the broader invention described herein.

Although not required, the embodiments described with reference to FIGS. 3 and 4 can be implemented via an application programming interface (API), for use by a developer, and can be included within another software application, such as a gaming machine operating system or a gaming server operating system. Generally, as program modules include routines, programs, objects, components, and data files that perform or assist in the performance of particular functions, it will be understood that a software application may be distributed across a number of routines, objects and components, but achieve the same functionality as the embodiment and the broader invention claimed herein. Such variations and modifications would be within the purview of those skilled in the art.

We claim:

1. A method for managing a plurality of namespace extensions in a XML file, comprising the steps of, parsing the file to identify the plurality of namespace extension elements and grouping the namespace extension elements into a single element.

2. A method in accordance with claim 1, wherein the step of grouping the namespace extensions comprises the further step of utilizing a set of rules to group the namespace extensions into the single element.

3. A method in accordance with claim 2, wherein the set of rules includes the rule of parsing each namespace extension element, identifying a common aspect to each of the namespace extension elements, identifying a difference between each of the namespace extension elements, and concatenating each difference to the common aspect.

4. A method in accordance with claim 1, comprising the further steps of creating a new XML file, and inserting the single element into the XML file in place of the plurality of namespace extension elements.

5. A method for managing a single namespace extension in a XML file, where the single namespace extension element contains a plurality of elements, comprising the steps of, parsing the file to identify the plurality of namespace extension elements contained within the single element, and extracting the plurality of namespace extension elements into separate elements.

6. A method in accordance with claim 5, wherein the step of extracting the namespace extension elements comprises the further step of utilizing a set of rules to extract the namespace extension elements into separate elements.

7. A method in accordance with claim 6, wherein the set of rules includes the rule of parsing the single namespace extension element, identifying a common aspect of each of the plurality of namespace extension elements, identifying a plurality of difference portions within the namespace extension elements, and separating each difference portion from the common aspect.

8. A method in accordance with claim 7, comprising the further steps of generating a plurality of namespace extension elements from the common aspect and each of the difference portions, and inserting the plurality of namespace extensions into the XML file in place of the single extension element.

9. A method in accordance with claim 8, comprising the further steps of creating a new XML file, and inserting the plurality of elements into the XML file in place of the single extension element.

10. A system for managing a plurality of namespace extensions in a XML file, comprising a parser which parses the file to identify the plurality of namespace extension elements, and a grouper which groups the namespace extension elements into a single element.

11. A system in accordance with claim 10, wherein the parser includes a grouper that utilizes a set of rules to group the namespace extensions into the single element.

12. A system in accordance with claim 11, wherein the set of rules utilized by the parser includes the rule of parsing each namespace extension element, identifying a common aspect to each of the namespace extension elements, identifying a difference between each of the namespace extension elements, and concatenating each difference to the common aspect.

13. A system in accordance with claim 10, wherein the parser creates a new XML file, and inserts the single element into the XML file in place of the plurality of namespace extension elements.

14. A system for managing a single namespace extension in a XML file, where the single namespace extension element contains a plurality of elements, comprising, a parser which parses the file to identify the plurality of namespace extension elements contained within the single element, and an extractor which extracts the plurality of namespace extension elements into separate elements.

15. A system in accordance with claim 15, wherein the parser includes an extractor that utilizes a set of rules to extract the namespace extension elements into separate elements.

16. A system in accordance with claim 15, wherein the parser parses the single namespace extension element, identifies a common aspect of each of the plurality of namespace extension elements, identifies a plurality of difference portions within the namespace extension elements, and separates each difference portion from the common aspect.

17. A system in accordance with claim 16, wherein the parser generates a plurality of namespace extension elements from the common aspect and each of the difference portions, and inserts the plurality of namespace extensions into the XML file in place of the single extension element.

18. A system in accordance with claim 17, wherein the parser creates a new XML file, and inserts the plurality of elements into the XML file in place of the single extension element.

19. A computer program arranged to, when loaded on a computing system, perform the method steps of one of claim 1 to claim 9.

20. A computer readable media incorporating computer program code in accordance with claim 19.

21. A data signal comprising computer program code accordance with claim 19.
